(19) United States
(12) Patent Application Publication
(10) Pub. No.: US 2008/0142606 A1
(43) Pub. Date: Jun. 19, 2008

(54) E-FUSE BAR CODE STRUCTURE AND METHOD OF USING THE SAME

(76) Inventor: Ping-Chang Wu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/612,480

(22) Filed: Dec. 19, 2006

(51) Int. Cl. G06K 19/06

(52) U.S. Cl. 235/494

(57) ABSTRACT

An invention relating to an eFuse bar code structure and a method of using the bar code structure is disclosed. The bar code structure includes a substrate and a plurality of eFuse elements disposed on the substrate and arranged in a form of an array, such that a bar pattern can be formed by the result of whether the fuse of the eFuse elements is blown or not. The method of using the bar code structure includes, with respect to a data, fuses of the eFuse elements in the bar code structure being correspondingly blown in accordance with an encoding method to form a bar pattern. The eFuse bar code structure according to the present invention can be manufactured by using a semiconductor manufacturing process, and thus it has small volume, a high density and may record a huge number of data.

### BACKGROUND OF THE INVENTION

1. Field of the Invention

The present invention relates to an e-fuse bar code structure and a method of using the bar code. More particularly, the present invention relates to a bar code structure using eFuses as a bar pattern and a method of using the same.

2. Description of the Prior Art

With the development of technology, it is desirable that the information regarding the raw materials, production and marketing of a product may be given for the record for inquiry or identification to facilitate the administration of manufactures, suppliers and the usage of consumers. The current solutions include Automatic Data Collection (ADC) such as bar codes, magnetic stripes, IC cards, etc. The data can be input into a database without the help of keyboards.

Magnetic stripes are useful in information storage, but high environmental demands, complicated reading devices and high cost are the disadvantages. Smart cards, i.e. IC cards, are integrated circuits encapsulated in a plastic card with an integrated microprocessor and a storage device to solve the problems that come with the traditional magnetic stripe cards such as low security and not being suitable for off-line operation. However, they are vulnerable, susceptible to magnetic fields, and need special care. Bar codes are symbols in which parallel spaces and lines are arranged according to certain encoding rules to represent certain letters or numbers. It is a reliable technology to fast input data with high accuracy, low cost and wide applications. It is also magnetism-resistant, static electricity-resistant and abrasion-resistant.

There are one-dimensional bar codes and two-dimensional bar codes. One-dimensional bar codes utilize the width of bars, and bars and spaces alternatively to stand for information. There are more than 20 types of bar code encoding protocols being currently used, such as Universal Product Code (UPC for short), Code 128, Code 39, EAN-13, etc. FIG. 1 illustrates an example of a conventional one-dimensional bar code. FIG. 2 illustrates the principle of bar codes in which the bar codes are scanned by an optical reader and the information is decoded through a decoder. Normally, the capacity of a one-dimensional bar code is 28 characters (impossible for Chinese characters). It requires portable or fixed readers to read the bar codes. Besides, as far as the light sources are concerned, there are two sorts of scanners: laser scanners and CCD scanners.

For two-dimensional bar codes, not only are horizontal bars and spaces are meaningful, but vertical dots are meaningful as well. Consequently, the data capacity is larger. There are many two-dimensional bar code encoding protocols, such as PDF417, CODE 49, CODE 16K, CODE 1, CODEBLOCK, VERICODE, DATA-CODE, MAXICODE, SUPERCODE, PHILIPS DOT CODE, ARRAYTAG, SOFTSTRIP, etc. FIG. 3 illustrates an example of a conventional two-dimensional bar code. The capacity of a two-dimensional bar code is about 1,000 characters, which can provide at least 500 Chinese characters. Therefore, it is not only useful in saving data sheets and word information, but also in saving image information. The data of an entire page of a sheet can be concentrated into a single bar code. The receiver may input the information of the sheet into a computer through an exclusive scanner automatically. Compared with floppy disks, it is not only abrasion-resistant, virus-free, demagnetization-free and damage-proof, but is also free from lack of capacity. The two-dimensional bar code is better than the one-dimensional bar code in many ways, such as security, capacity and data-traceability.

However, the current demand of bar codes being light, thin, short, small, and compact and high reliability is increasing. In addition, it is also desirable for the ID bar code devices which are disposed on a product and able to collect real time information during production or from logistic line for the record.

U.S. Pat. No. 6,179,207 B1 discloses certain encoding methods for one-dimensional bar codes, such as BC412, BC313, BC411, BBC31 and BC311, for representing letters and numbers, as well as a method for marking bar codes on a substrate by laser.

In another field, there has been a significant development in eFuse elements. With the miniaturization of semiconductor production and the increase of elaborateness, semiconductor devices are more susceptible to all kinds of defects and impurities. Failure of a single interconnect, diode or transistor will lead to the defect of the entire wafer. In order to solve this problem, the current solution is to form some fusible links, i.e. fuses, to ensure the availability of the integrated circuits. Generally speaking, fuses are linked to the redundancy circuits in the integrated circuits. Once the circuits are found to be defected, these fusible links are useful in repairing or replacing the defected circuits.

As far as the operation method is concerned, fuses may be generally divided into thermo-fuses and eFuses. The eFuses are blown to form broken circuit due to electro-migration phenomenon for repair purpose.

There are many known eFuse structures. FIG. 4 illustrates one of them. An eFuse structure 10 includes an eFuse 12, and extends an anode 14 and a cathode 16 to an external circuit. A junction 18 exists in the electric connection where the eFuse 12 and the cathode 16 meet each other. In general cases, the eFuse structure 10 is a backup, and only serves as a redundancy circuit of the integrated circuits. When repair or programming is initiated, proper electric current will pass through the eFuse structure 10 to cause electro-migration of the eFuse 12. When large current is continuously passing through the eFuse structure 10, the higher the current density, the higher the electric field, which drives atoms to move along the grain boundary of the material in the direction of electron flow. The current density increases with the increasing degree of electro-migration, and finally the junction 18 in FIG. 1 breaks off to leave a broken circuit once the electro-migration is overdone. As a result, the broken circuit completes the desired repair or programming operation.

Nevertheless, it is not yet disclosed that a plurality of eFuse structures serve as a bar code. Furthermore, the Industrial demand for better bar code structure still exists.

### SUMMARY OF THE INVENTION

It is one objective of the present invention to provide a bar code structure and the method for using the bar code structure. The bar code structure is light, thin, short, and small with the advantages of high storage density and high reliability for use in keeping a record of the information of a product or during its production.

The eFuse bar code structure in accordance with the present invention comprises a substrate, and a plurality of eFuse elements disposed on the substrate and arranged in a form of an array such that a bar pattern is formed by the result of whether the fuse of the eFuse elements is blown or not.

The method for using the eFuse bar code which comprises a substrate and a plurality of eFuse elements disposed on the substrate and arranged in a form of an array in accordance with the present invention comprises blowing a fuse in the corresponding eFuse elements with respect to a piece of information according to a bar code encoding method to form a bar pattern corresponding to the piece of information.

The eFuse bar code structure in accordance with the present invention uses eFuses as a bar pattern. The eFuses can be manufactured by semiconductor processes. The advantages are to downsize to a small and to have compact size and the ability to store a lot of information in a unit volume. Voltages are applied on the junctions to blow the fuses. It is convenient to use electric signals or optical scanning to read the information. Due to the fact that a lot of information is stored in a unit volume, information in Chinese may be saved through proper encoding and decoding methods. In addition, batch information is possible. In other words, information can be added to the same bar code structure successively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an example of a conventional one-dimensional bar code.

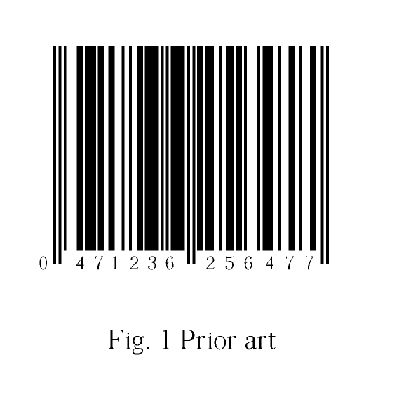

FIG. 2 illustrates an example of decoding a conventional one-dimensional bar code.

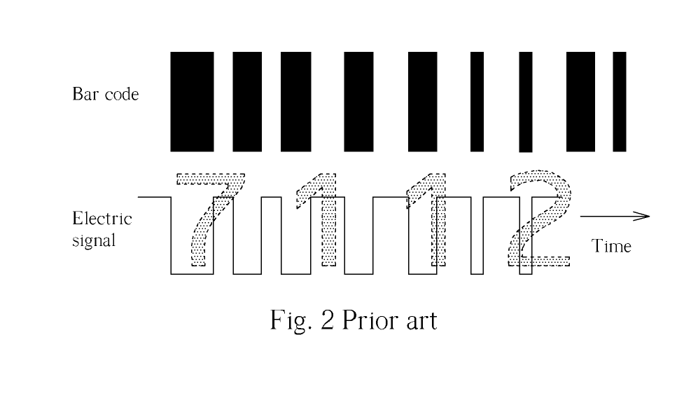

FIG. 3 illustrates an example of a conventional two-dimensional bar code.

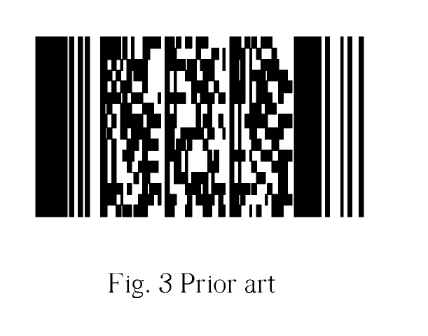

FIG. 4 illustrates an example of conventional eFuse structure.

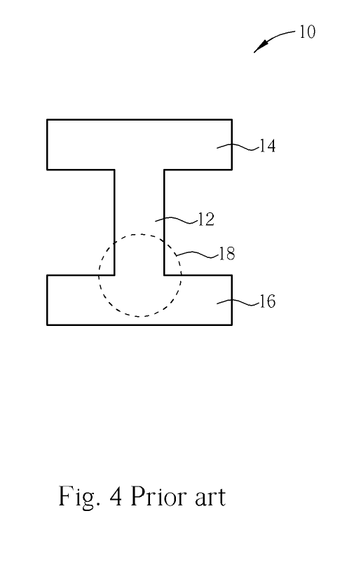

FIG. 5 is a top view of an embodiment of the eFuse bar code structure according to the present invention.

FIG. 6 illustrates the A section of the bar code structure in FIG. 5 and the section view along line I-I′.

FIG. 7 is a schematic view of the blown eFuse element in FIG. 6 after a voltage is applied.

FIG. 8 is a schematic view of the eFuse bar code structure according to the present invention after use.

FIG. 9 is a method of encoding disclosed in U.S. Pat. No. 6,179,207.

FIG. 10 illustrates an embodiment of the eFuse bar code structure according to the present invention in a three-dimensional arrangement.

### DETAILED DESCRIPTION

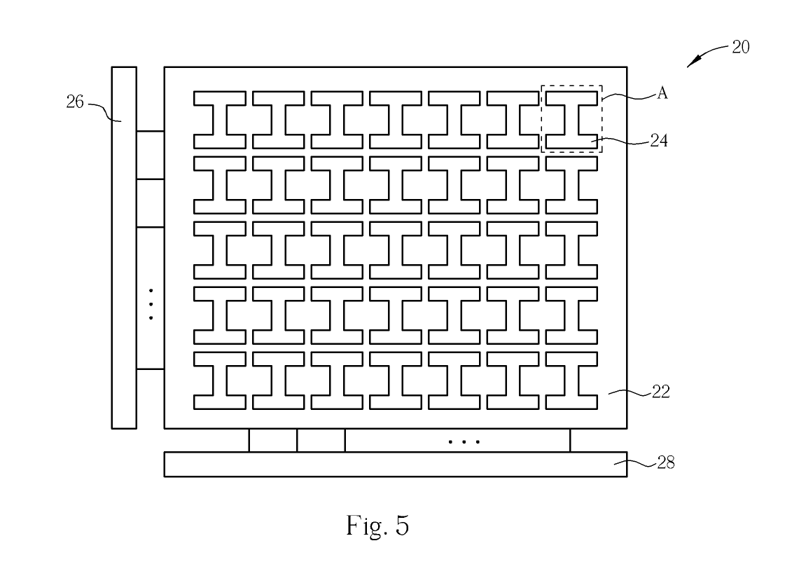

Please refer to FIG. 5. FIG. 5 is a top view of an embodiment of the eFuse bar code structure according to the present invention. The eFuse bar code structure 20 comprises a substrate 22 and a plurality of eFuse elements 24 disposed on substrate 22. The substrate 22 may be a semiconductor substrate for facilitating the production of the eFuse elements. The eFuse elements 24 may be one-dimensionally, two-dimensionally or three-dimensionally (i.e. multi-layer) arranged in a form of an array. FIG. 5 illustrates an example of two-dimensional arrangement. The eFuse bar code structure 20 may further comprise a plurality of electric circuits for separately electrically connecting the eFuse elements to an external circuit. For example, in the case of reading process, it may be electrically connected to row decoder 26 and column decoder 28 for decoding. It may be connected to a signal amplifier for amplifying signals.

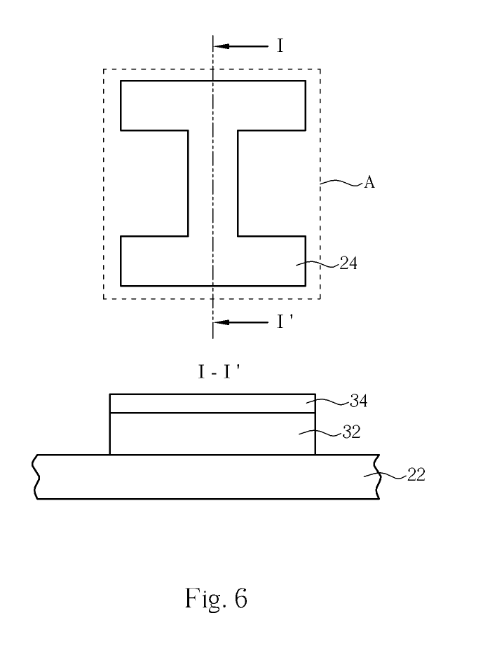

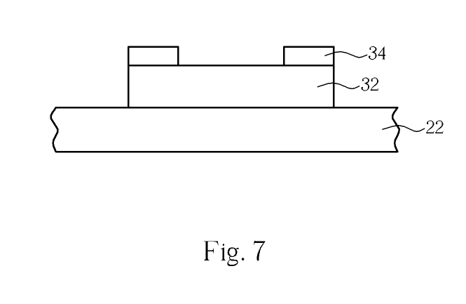

FIG. 6 illustrates the A section of the eFuse bar code structure in FIG. 5 and the section view along line I-I′. This is an example of the eFuse element structure only, but the present invention is not limited to this example, and other eFuse structures can be used. The eFuse elements 24 are deposited on the substrate 22 and comprise a polysilicon layer 32 and a polycide layer 34 stacked on the polysilicon layer 32. Polysilicon is a material of low resistance. Polycide is a material of high resistance. The stacking shape of polysilicon layer 32 and polycide layer 34 is narrow in the middle and wide at both ends. Consequently, when the two ends of the polycide layer 34 serve as cathode and anode and a voltage is applied on the polycide layer 34, strong electric current is continuously passing through the polycide layer 34. The narrower the passage, the higher the electric current density. Due to the electro-migration effect, the atoms in the polycide layer migrate along the lattice in the direction of electron flow. This makes the eFuse elements 24 break off in the middle region to form two separate end segments without electric connection. FIG. 7 is a schematic view of a blown eFuse element 24 in FIG. 6 after a voltage is applied. Furthermore, a protection layer, such as a thin silicon oxide layer, may be applied on the polycide layer to protect it.

When a plurality of eFuse elements are arranged one-dimensionally, they resemble a one-dimensional bar code. When eFuse elements are arranged two-dimensionally, they resemble a two-dimensional bar code. In addition to being electrically encoded and optically decoded, the eFuse bar code structure of the present invention may be electrically encoded and decoded as well. They can also be arranged three-dimensionally without any difficulty in structure and for use.

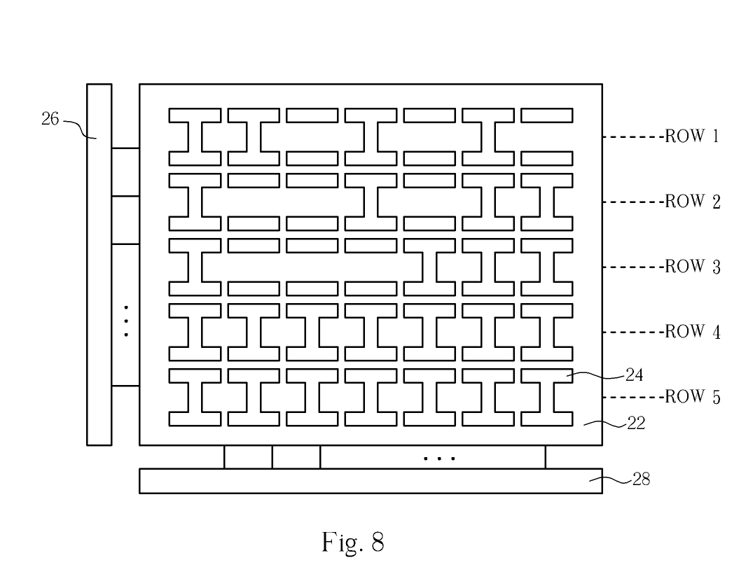

The eFuse bar code structure according to the present invention may be patterned by blowing a fuse in the corresponding eFuse elements with respect to a piece of information according to a bar code encoding method to form a bar pattern corresponding to the information. For example, FIG. 8 is a schematic view after use. Some fuses in the eFuse elements 24 are blown to form a bar pattern.

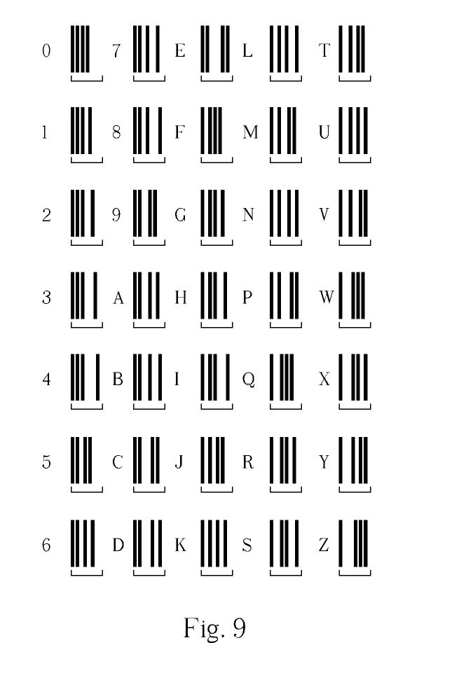

The pattern variations of the bar code structure may be referred to the conventional bar code encoding methods. For example, FIG. 9 is a method of encoding BC412 disclosed in U.S. Pat. No. 6,179,207, regulating that a number or a letter may be represented by the existence or absence of seven lines. The encoding method of the eFuse bar code structure of the present invention may be BC412 method. For example, the first row in FIG. 8 represents number “7,” the second row for letter “Y” and the third row for letter “Z.” The forth and the fifth rows are not in use at present.

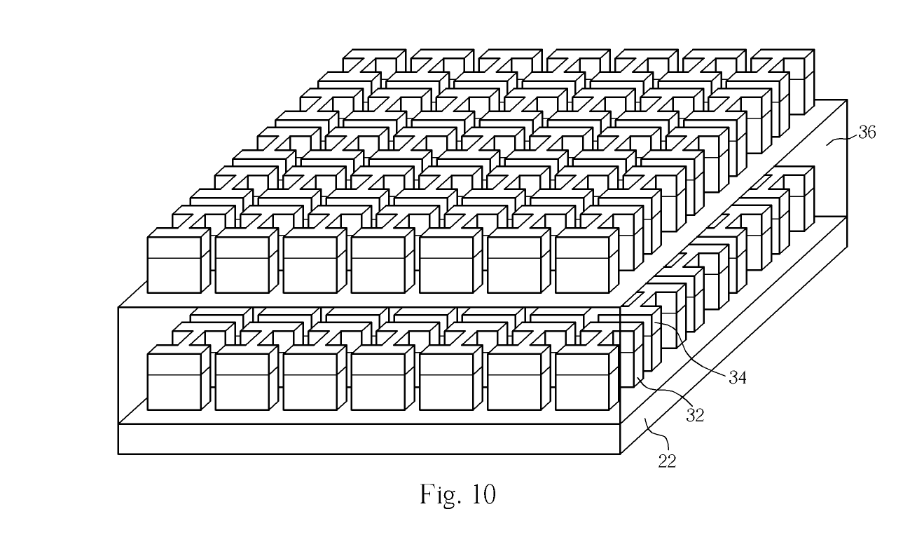

The eFuse bar code structure according to the present invention may be arranged three-dimensionally. FIG. 10 illustrates an embodiment in a three-dimensional arrangement. For example, after a layer of eFuse elements and the necessary circuits are formed on the substrate, an insulation layer 36 of dielectric material, such as silicon oxide layer, may be deposited thereon as the substrate of the eFuse elements on the next higher layer to continue the production of the eFuse elements. A protection layer may be further deposited on the top layer of the eFuse elements.

There are many methods to “break” the fuse in the corresponding eFuse elements. For example, the method may be carried out by connecting the eFuse elements to an external circuit for applying a voltage on the fuse, i.e. applying a proper voltage to “break” the eFuse. Subsequently, a bar pattern is formed on the bar code structure. To break an eFuse, in plain words, is to have an eFuse “blown” by means of electro-migration effect. The term “blown” used herein is not particularly construed as “having a fuse broken by means of heat”.

To do decoding is to read the fuse in the eFuse elements to determine if the fuse is blown or not, so as to obtain the corresponding information. To determine if the fuse is blown or not may be carried out by connecting the eFuse elements to an external circuit for reading electric signals. Different electric signals help to determine if the fuse is blown or not because blown or unblown fuses represent different electric signals. It may also be possible to optically determine if the fuse is blown or not by optically scanning the bar pattern formed by blown or unblown fuses. This resembles the traditional way to scan the bar codes to obtain information.

The eFuse bar code structure according to the present invention may be applied in many aspects. It may be useful in recording information comprising process information of a product, test information before, during or after production, quality information or identification information, etc. The bar code structure in accordance with the present invention uses eFuses as a bar pattern. They can be manufactured by semiconductor process. The advantages are the small and compact size and the ability to store a lot of information in a unit volume and batch information.

The eFuse bar code structure according to the present invention is especially useful in semiconductor processes and keeping track of product records. For example, the bar code structure may be built on the semiconductor substrates of each die in accordance with the production process to keep tracking of production, QC and logistic record after production. Because the bar code structure is small, compact, information-concentrated and stable, information such as batch number, die number, test number and results, packing number and test results can be recorded successively. It can also be used to identify each die. Accordingly, the eFuse bar code structure of the present invention may be conveniently applied to other products. For example, the eFuse bar code structure may be attached onto a product (agricultural or electronic products, for example) during or after production or onto its package to record the information successively.

The so-called action of “to record the information successively” means to form another bar pattern according to a bar code encoding method with respect to another piece of information after a period of time by blowing a corresponding fuse which has not been used for forming the bar code pattern (the forth and the fifth rows in FIG. 8, for example) in the eFuse elements. Therefore, it is another feature of the present invention that information can be added to the same bar code structure successively. For example, an eFuse bar code structure of the present invention may be formed on a proper place of a certain die during the production to record the batch number and the die number. Later, the information such as production conditions, test number and test results, etc. may be recorded in the same bar code structure utilizing the region which has not been used after preliminary tests. Then, the test results after packaging test can be successively recorded. All information in the same bar code structure facilitates the complete track record of a product. The advantages are essentially based on the large capacity of the eFuse bar code structure and the principle of the eFuse. A single bar code structure provides all information since production without having to be constantly replaced like conventional bar codes. It is therefore environment-friendly as well.

The eFuse bar code structure in accordance with the present invention can be manufactured by semiconductor processes. The advantages are the small and compact size compared to the conventional one. For example, the distance between each line can be shorter than 1 μm. So 1 mm² area may contain about 10⁶ lines. Accordingly, a lot of information can be stored in a unit volume. Moreover, batch information is possible. In other words, information can be added to the same eFuse bar code structure successively.

All combinations and sub-combinations of the above-described features also belong to the present invention. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An eFuse bar code structure comprising:
a substrate; and
a plurality of eFuse elements disposed on said substrate and arranged in a form of an array, such that a bar pattern is formed by the result of whether the fuse of said eFuse elements is blown or not.

2. The eFuse bar code structure of claim 1 wherein said eFuse elements are in a one-dimensional arrangement.

3. The eFuse bar code structure of claim 1 wherein said eFuse elements are in a two-dimensional arrangement.

4. The eFuse bar code structure of claim 1 wherein said eFuse elements are in a three-dimensional arrangement.

5. The eFuse bar code structure of claim 1, further comprising a plurality of circuits for separately electrically connecting said eFuse elements to an external circuit.

6. The eFuse bar code structure of claim 1 wherein said substrate is a semiconductor substrate.

7. The eFuse bar code structure of claim 1 wherein said substrate is a semiconductor substrate in a die.

8. A method for using an eFuse bar code, said eFuse bar code comprising a substrate and a plurality of eFuse elements disposed on said substrate and arranged in a form of an array, the method comprising:
blowing at least one selected fuse in said plurality of eFuse elements with respect to a piece of information according to a bar code encoding method to form a bar pattern corresponding to said piece of information.

9. The method of claim 8 wherein blowing the at least one selected fuse in said plurality of eFuse elements is carried out by connecting said eFuse elements to an external circuit for applying a voltage on said fuse.

10. The method of claim 8, further comprising:
reading said at least one selected fuse in said plurality of eFuse elements to determine if said fuse is blown or not to obtain the corresponding information of said bar pattern.

11. The method of claim 10 wherein reading said at least one selected fuse in said plurality of eFuse elements to determine if said fuse is blown or not is carried out by connecting said eFuse elements to an external circuit for reading electric signals.

12. The method of claim 10 wherein reading said at least one fuse in said plurality of eFuse elements to determine if said fuse is blown or not is carried out by optically scanning said bar pattern formed by unblown and blown fuses of said eFuse elements.

13. The method of claim 8, wherein said piece of information comprises process information of a product, test information before, during or after production, quality information or identification information.

14. The method of claim 13, further comprises:
attaching said eFuse bar code onto said product or onto a package of said product.

15. The method of claim, 8 further comprising:
blowing at least one other fuse which has not been used for forming said bar code pattern in said eFuse elements to form another bar pattern according to the bar code encoding method with respect to another piece of information after a period of time.
